(19) United States
(12) Patent Application Publication
(10) Pub. No.: US 2009/0267481 A1
(43) Pub. Date: Oct. 29, 2009

(54) CAPPED ELECTRIC LAMP

(75) Inventor: Jos Verheyen, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,446

(22) PCT Filed: Dec. 17, 2007
(86) PCT No.: PCT/IB07/55156

§ 371 Date: Jun. 16, 2009

(30) Foreign Application Priority Data
Dec. 22, 2006 (EP) 06126988.2

(51) Int. Cl. H01J 5/60

(52) U.S. Cl. 313/318.1

(57) ABSTRACT

The invention relates to a capped electric lamp provided with an outer bulb (3) which encloses a light source and is closed at one end by means of a cementless mounted lamp cap (4) having a collar (47) which surrounds the end with clearance (5). According to the invention, a helical spring (6) having a winding of at least one turn around the end is enclosed in the clearance between the collar and the end of the outer bulb, a first tip (61) of said spring being pushed against the collar and a second tip (62) resting in a recess in the end of the outer bulb.

### FIELD OF THE INVENTION

The invention relates to a capped electric lamp provided with an outer bulb which encloses a light source and is closed at one end by means of a cementless mounted lamp cap having a collar which surrounds the end with clearance. In most cases, the lamp will have an axis of rotation for rotating the lamp when placed in a lamp holder.

### BACKGROUND OF THE INVENTION

A lamp of the type mentioned above is known from GB 767971. In the known lamp, a metal strip is provided in a recess in the end of the outer bulb and is soldered to a skirt of the lamp cap reaching over the end of the outer bulb.

It is true that the known lamp counteracts the drawback of using cement for the joint between the outer bulb and the lamp cap, but this has led to a very complex production process because soldering can only take place after the lamp cap has been placed in position on the end of the outer bulb. Due to this complexity, there will be a relatively large percentage of rejects, which is a very serious problem in large-scale industrial production.

Besides these drawbacks, there is the risk of breakage of the soldered joint, especially when the lamp is taken out of its holder at the end of its life. With the lamp cap still being electrically connected to the lamp holder, such breakage of the soldered joint will give rise to very dangerous situations upon separation of the cap from the outer bulb.

### OBJECT AND SUMMARY OF THE INVENTION

It is an object of the present invention to provide a lamp having a construction with which the above-mentioned drawbacks are counteracted.

According to the invention, the lamp described in the opening paragraph is characterized in that a helical spring having a winding of at least one turn around the end is enclosed in the clearance between the collar and the end of the outer bulb, a first tip of said spring being pushed against the collar and a second tip resting in a recess in the end of the outer bulb. The direction of the turn of the helical spring when taken from the first tip towards the second tip preferably coincides with the direction of rotation of the lamp during its placement in a lamp holder.

The lamp according to the invention has the important advantage that a joint between the outer bulb and the lamp cap is realized by a simple, purely mechanical construction, without using cement or solder. When the outer bulb is rotated in the direction that coincides with the direction from the first tip towards the second tip of the helical spring, the cap is fastened on the end of the outer bulb. When the outer bulb is subsequently rotated in the opposite direction, the spring expands against the cap whilst its second tip position is fixed by the recess in which it is enclosed. Consequently, the cap stays fixed on the end of the outer bulb. When said direction of rotation for fastening the cap on the outer bulb end is the same as the direction of rotation for placing it in a lamp holder, the lamp has the further advantage that the joint between the outer bulb and the cap is self-strengthening on turning the lamp into and out of a lamp holder. The construction of the joint between the lamp cap and the outer bulb of the lamp has the further advantage that it is not subject to ageing. In addition to the above-mentioned advantages, the production process of mounting the lamp cap on the outer bulb is effectively simplified and made far more reliable, which is of utmost importance in large-scale industrial production.

In a further advantageous embodiment of the lamp according to the invention, the second tip is placed substantially parallel to the axis of rotation. In this way, the forces exerted on the recess section and immediate surroundings of the end of the outer bulb are kept easily limited when the lamp cap is screwed onto the end of the outer bulb and the lamp is screwed into a lamp holder. More in general, the second end tip is formed with a protuberance extending from the plane of the helical spring substantially parallel to the axis of rotation. An extension substantially parallel to the axis of rotation may have any shape. An effective length of 1 mm in the direction parallel to said axis is already extremely effective in reducing the risk of damaging the end of the outer bulb.

A further improvement is achieved in that the winding in a lamp according to the invention has at least 1.25 turns and extends over the second tip. In a simple and effective way, the winding thus provides its own securing of the second end. This is particularly advantageous in the process of mounting the lamp cap on the outer bulb.

In a further advantageous embodiment of a lamp according to the invention, the collar of the cap or the end of the outer bulb or both are provided with means which abut the first tip when the outer bulb is rotated with respect to the cap in the direction from the first tip towards the second tip. It is thus advantageously achieved that the cap cannot continue to rotate with respect to the outer bulb when the cap is fastened on the end and/or when the lamp is placed in a lamp holder. When the cap is fastened on the end, the endless rotation of the cap may result in breakage of the end of the outer bulb due to the exerted force of the helical spring being wound up during the rotation. When the lamp is placed in a lamp holder, there is the risk of breakage of the outer bulb in addition to the risk of damage of the joint between the lamp holder and the cap. The shape of the abutting means can be freely chosen from a large number. For instance, the abutment is formed by a small indentation in the collar of the cap. Alternatively, the abutting means may be formed by a bulge or a protuberance on the end of the outer bulb.

In a further advantageous embodiment, the light source has an electric conductor which is connected to a contact point on the lamp cap by means of a clamping fit between the collar of the lamp cap and the winding of the helical spring.

These and other aspects of the invention will be elucidated with reference to the drawings.

### BRIEF DESCRIPTION OF THE DRAWINGS

In the drawings:

FIG. 1 shows an embodiment of a lamp having a lamp cap according to the invention;

FIG. 2 is a detailed exploded view of the lamp end and the closing cap;

FIGS. 3A and B show, in detail, the lamp end with the helical spring;

FIG. 4 shows, in detail, a lamp end on which the spring is mounted in a further embodiment;

FIGS. 5A and B are cross-sections of the lamp end with the mounted cap, and

FIGS. 6A and 6B are detailed cross-sectional views of the outer bulb end along the axis of rotation.

### DESCRIPTION OF EMBODIMENTS

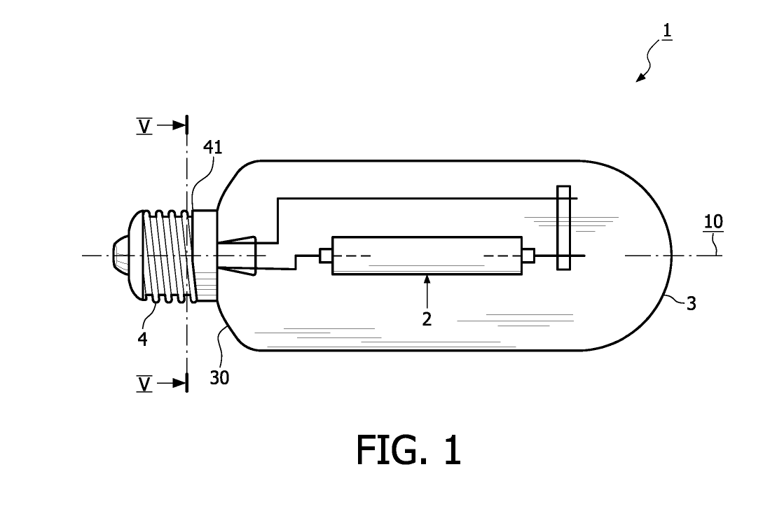

FIG. 1 shows a lamp 1 having an outer bulb 3 which accommodates a light source 2. The outer bulb 3 has an end 30, which is closed by means of a cap 4 mounted in a cementless way. The lamp has an axis of rotation 10 for rotating the lamp when placed in or taken out of a lamp holder.

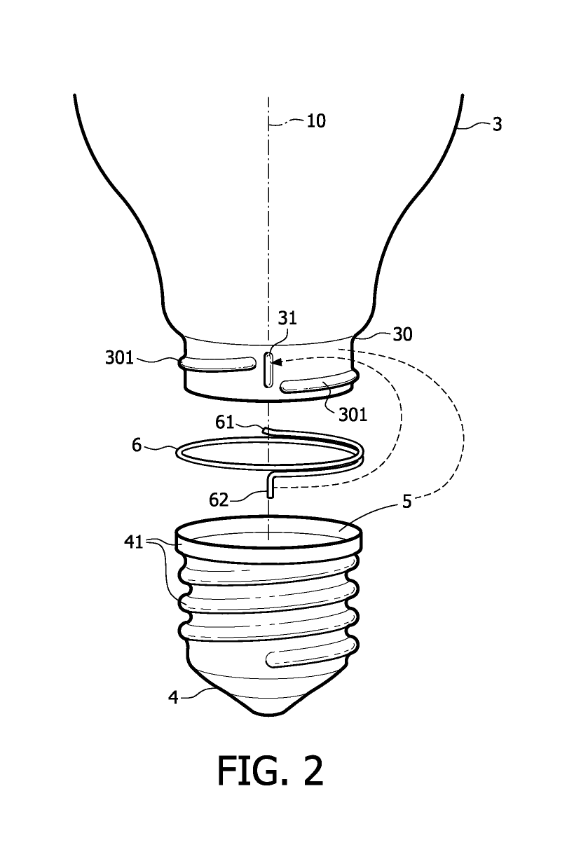

The end 30 closed by the cementless mounted cap 4 is shown in further detail in an exploded view in FIG. 2. The cap has a collar 41 which surrounds the outer bulb end 30 with clearance 5. A helical spring 6 having a winding of at least one turn is enclosed in the clearance. In the embodiment shown, the spring 6 has a winding of 1.5 turns.

The outer bulb end 30 has a profile 301 which cooperates with both the collar 41 and the helical spring 6. The direction of the turn of the winding taken from a first tip 61 towards a second tip 62 coincides with the rotation of the outer bulb 3 with respect to the cap 4 when the cap is fastened onto the end 30 of the outer bulb. The first tip 61 is thereby pushed against the collar 41 of the cap 40 and the second tip 62 fits in a recess 31 of the end 30. In the embodiment shown, the second tip 62 is placed substantially parallel to the axis of rotation 10.

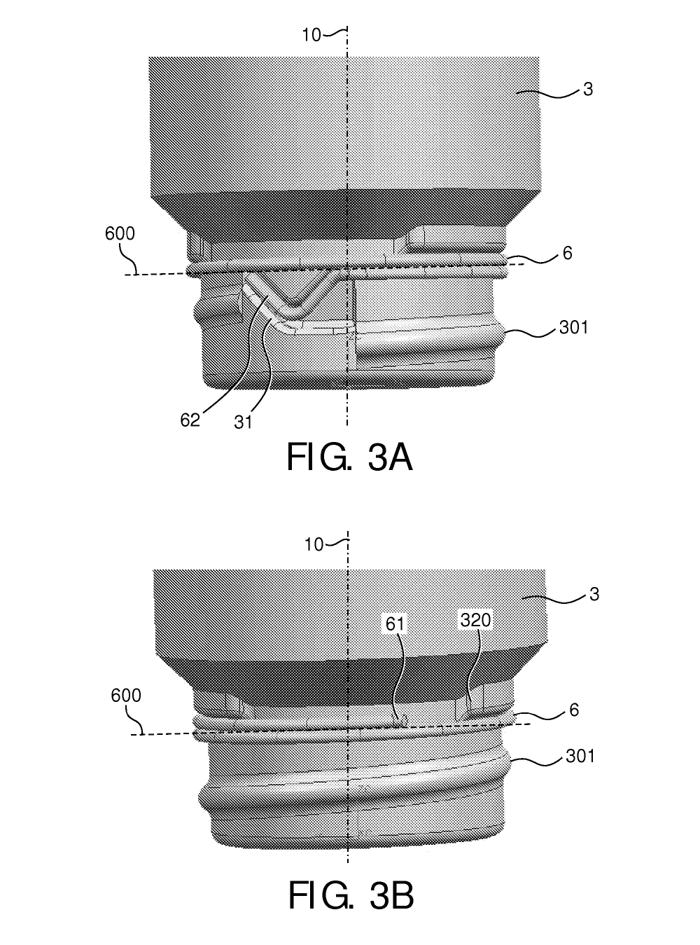

A further embodiment of the end 30 is shown in detail in FIGS. 3A and 3B. FIG. 3A shows an alternative shape of the second tip 62 formed by a protuberance extending from the plane 600 of the helical spring winding substantially parallel to the axis of rotation 10, in this practical case in the shape of a V. Roughly opposite thereto, the first tip 61 of the helical spring is bent slightly outwards. Consequently, when the cap is mounted, the tip end 61 points towards the collar, which improves the interaction between the helical spring tip end 61 and the lamp cap 30. In the embodiment shown, the end 30 of the outer bulb 3 is provided with a protuberance 320 acting as an abutment for the first tip 61 of the helical spring.

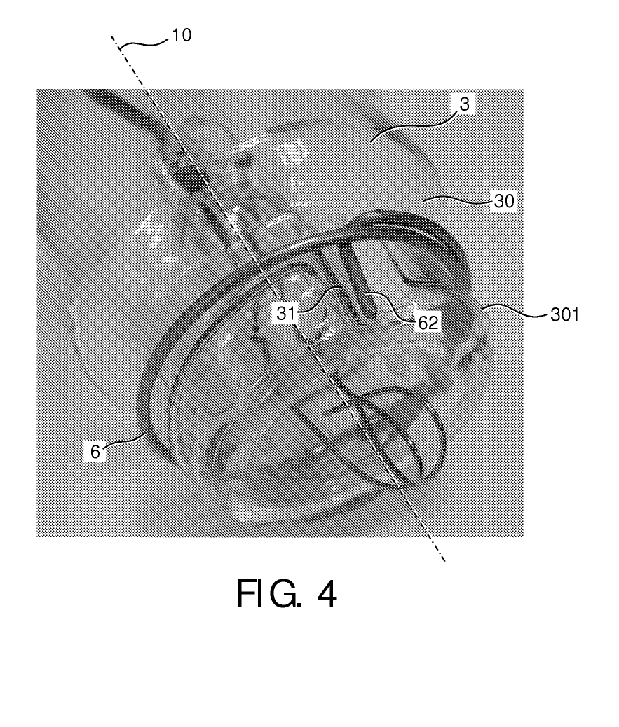

The detailed end 30 of a further alternative embodiment of the lamp according to the invention is shown in FIG. 4. In this embodiment, the helical spring has such a construction that the turn of the winding locks the second tip end 62 into the recess 31 of the end 30. In this embodiment, the winding thus has at least 1.25 turns and extends over the second tip 62.

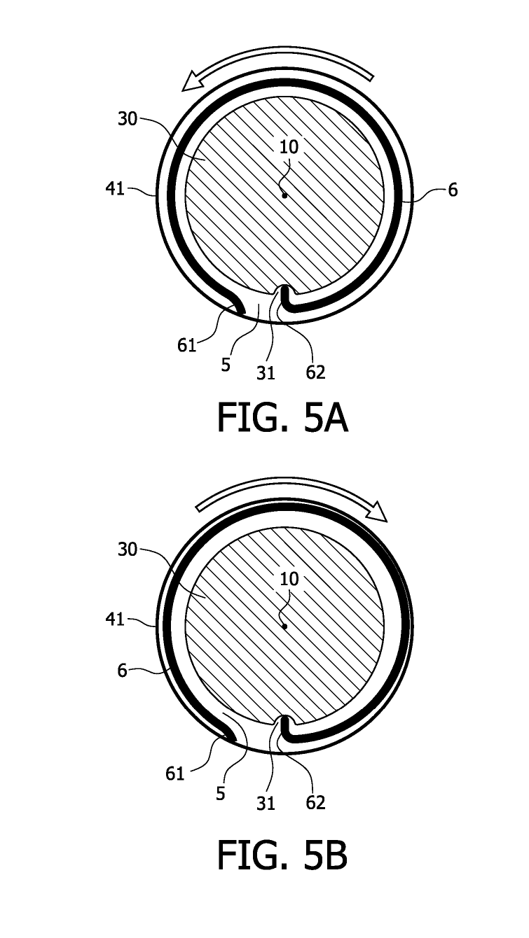

FIGS. 5A and 5B are cross-sections taken on the line V-V in FIG. 1 through the end 30 of the outer bulb 3 with the cap 4 mounted as in FIG. 1 .The arrow in each Figure indicates the direction of rotation of the outer bulb with respect to the cap. FIG. 5A thus shows the situation in which the cap 4 is fastened onto the end 30 of the outer bulb 3. This is in contrast with the situation shown in FIG. 5B, in which the rotation of the outer bulb 3 forces the cap to rotate in the same direction as soon as the spring has expanded substantially fully against the collar 41 of cap 4.

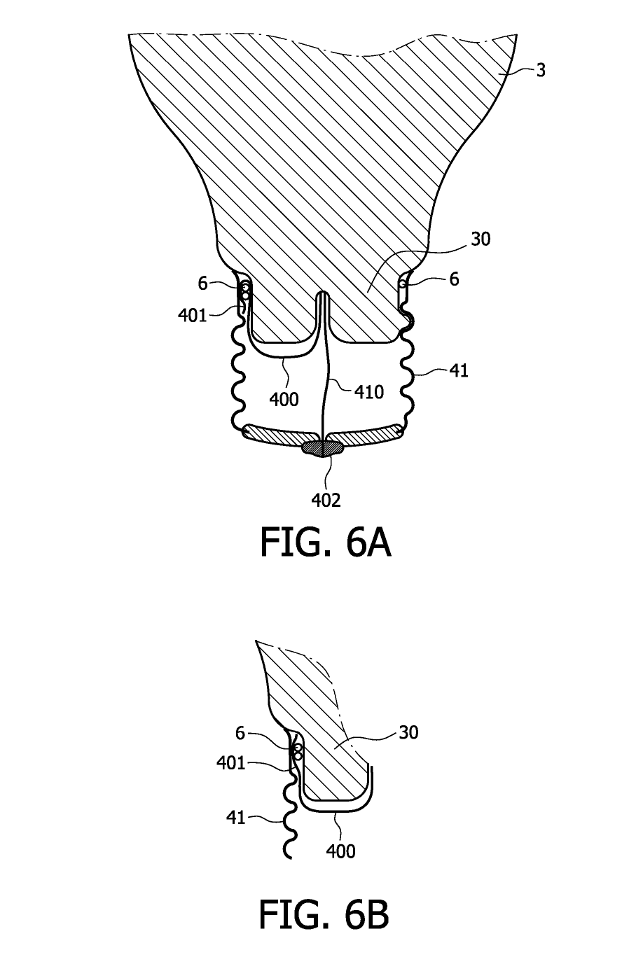

FIGS. 6A and 6B are detailed cross-sectional views of the outer bulb end along the axis of rotation of a lamp according to the invention. The light source 2 has an electric conductor 400 which is connected to a contact point 401 on the lamp cap 4 by means of a clamping fit between the collar 41 of the lamp cap and the winding of the helical spring 6. A further conductor 410 has a conventional bottom contact 402 at the end of the lamp cap.

1. A capped electric lamp comprising an outer bulb which encloses a light source and is closed at one end by means of a cementless mounted lamp cap having a collar which surrounds the end with clearance, wherein a helical spring having a winding of at least one turn around the end is enclosed in the clearance between the collar and the end of the outer bulb, a first tip of said spring being pushed against the collar and a second tip resting in a recess in the end of the outer bulb.

2. A capped electric lamp according to claim 1, comprising an outer bulb which encloses a light source and is closed at one end by means of a cementless mounted lamp cap having a collar which surrounds the end with clearance, the lamp having an axis of rotation for rotating the lamp when placed in a lamp holder, wherein a helical spring having a winding of at least one turn is enclosed in the clearance between the collar and the end of the outer bulb, a first tip of said spring being pushed against the collar and a second tip resting in a recess in the end of the outer bulb, the direction of the turn of the helical spring when taken from the first tip towards the second tip coinciding with the direction of rotation of the lamp during its placement in said lamp holder.

3. A lamp according to claim 1, wherein the second tip is placed substantially parallel to the axis of rotation.

4. A lamp according to claim 1, wherein the helical spring is located in a plane and the second tip has a protuberance extending from the plane substantially parallel to the axis of rotation.

5. A lamp according to claim 1, wherein the winding has at least 1.25 turns and extends over the second tip.

6. A lamp according to claim 1, wherein the light source comprises an electric conductor which is connected to a contact point on the lamp cap by means of a clamping fit between the collar of the lamp cap and the winding of the helical spring.

7. A lamp according to claim 1, wherein the collar of the cap or the end of the outer bulb or both comprise means which abut the first tip when the outer bulb is rotated with respect to the cap in the direction from the first tip towards the second tip.
